(19) United States
(12) Patent Application Publication
(10) Pub. No.: US 2014/0298223 A1
(43) Pub. Date: Oct. 2, 2014

(54) Systems and methods for drawing shapes and issuing gesture-based control commands on the same draw grid

(71) Applicants: Peter Duong, Mississauga (CA); Pasan Hapuarachchi, Thornhill (CA); Anthony Duong, Mississauga (CA)

(72) Inventors: Peter Duong, Mississauga (CA); Pasan Hapuarachchi, Thornhill (CA); Anthony Duong, Mississauga (CA)

(21) Appl. No.: 14/172,791

(22) Filed: Feb. 4, 2014

Related U.S. Application Data
(60) Provisional application No. 61/761,664, filed on Feb. 6, 2013.

(51) Int. Cl. G06F 3/0484; G06F 3/0488; G06F 3/0481

(52) U.S. Cl. CPC G06F 3/04845; G06F 3/04817; G06F 3/04842; G06F 3/0488
USPC 715/765

(57) ABSTRACT

The present invention improves upon the existing touch based systems by introducing new mechanisms of interaction with the user that can improve the productivity of users that are creating and modifying diagrams and figures on such touch based systems. More specifically, without leaving the draw grid, the invention allows the user to seamlessly copy one or more objects, delete one or more objects, change the type and end type of a connector between two objects, change the color of an object, and create a sequence diagram. The above mentioned control gesture operations do not require the user to click or select a button that is outside the draw grid to achieve a particular control objective.

This application claims priority to U.S. Provisional Application No. 61/761,664, filed on Feb. 6, 2013.

### TECHNICAL FIELD

The disclosed embodiments relate generally to subject matter wherein presentation of data to a computer operator of a system contains components that enable interaction by nonverbal representations and symbols. More particularly, the preferred embodiments relate to a client component that has a graphical user interface that allow the user to interact with the client component through gestures to both draw new shapes/objects and to issue control commands in the same editing mode.

### BACKGROUND

Flow chart diagraming tools, such as Microsoft Visio, exist in the industry that allow users to create flow and process diagrams by dragging and dropping various components from a list of components to a work grid and to create any appropriate connections between the components.

However, this form of interaction and diagram creation is not ideal on touch based devices. Society is becoming increasingly mobile and touch based systems such as smartphones and tablets are becoming more pervasive among users. As portable electronic devices become more common in our society, there is an increased demand to allow users to leverage such devices and systems to create, modify, interact with, transmit and receive content.

While touch based systems that allow diagraming by users do exist in the current market, they do not integrate control operations into the same input flow as drawing the shapes/components. For example, to delete an existing object, some applications may require the user to select the object and to click on a delete button with the mouse or alternatively to hit the delete key. However, on a tablet device, a physical keyboard may not be available and it may be inconvenient to move away from the work grid and possibly scroll through menus to find the delete button.

One of the goals of this document is to alleviate such inconveniences by introducing gesture based draw and control input operations that can co-exist in the same work flow. With this approach, gestures that are considered to be control gestures are drawn on the same draw grid that contains the shapes and components that are drawn with draw gestures.

### SUMMARY OF THE INVENTION

The present invention improves upon the existing touch based systems by introducing new mechanisms of interaction with the user that can improve the productivity of users by supporting draw shape gestures and control gesture operations, both drawn on the same draw grid. It is important to note that a control gesture operation, as the term is used in this document, does not include clicking or selecting a button that is outside the draw grid to achieve a particular control objective. Moreover, as described in the detailed description, manipulating a control widget would also not be considered to be a control gesture operation.

In one embodiment of the present invention there is provided a primary client system that enables gesture based interaction with a primary user, the primary client system comprising 1) a primary draw grid that enables interaction between the primary client system and the primary user by means of input gesture operations and 2) a primary pattern recognition component that interprets the input gestures. Here, the input gesture operations include one or more draw shape gestures and one or more control gesture operations that are drawn within the boundaries of the primary draw grid.

In another embodiment of the present invention there is provided a method that enables gesture based interaction between a primary user and a primary client system that includes a primary draw grid. The method comprises 1) the primary client system receiving from the primary user two or more input gesture operations and 2) a pattern recognition component of the primary client system determining two or more recognized gesture commands, by determining, for each of the two or more input gesture operations, one or more recognized gesture commands. Here, each input gesture operation is entered by the primary client through the primary draw grid and the two or more input gesture operations include one or more draw shape gestures and one or more control gesture operations drawn within the boundaries of the primary draw grid. Also, the two or more recognized gesture commands include one or more draw shape commands and one or more recognized control commands.

In another embodiment of the present invention there is provided a computer program product for use on a primary client system that enables gesture based interaction with a primary user. The computer program product comprises a non-transitory recording medium and instructions recorded on the non-transitory recording medium for instructing the primary client system to receive from the primary user two or more input gesture operations and to determine two or more recognized gesture commands, by determining, for each of the two or more input gesture operations one or more recognized gesture commands. Here, each input gesture operation is entered by the primary user through a primary draw grid of the primary client system and the two or more input gesture operations include one or more draw shape gestures and one or more control gesture operations. Also, the two or more recognized gesture commands include one or more draw shape commands and one or more recognized control commands.

### BRIEF DESCRIPTION OF THE DRAWINGS

Embodiments of the present invention will be described more fully with reference to the accompanying drawings in which:

FIG. 1 illustrates the components of an embodiment of the primary client system;

FIG. 2 illustrates the interpretation of input gesture operations by a primary pattern recognition component;

FIG. 3 illustrates the copying of objects on an embodiment of the primary client system;

FIG. 4 illustrates the deleting of objects on an embodiment of the primary client system;

FIG. 5 illustrates the changing of the line type of a connector on an embodiment of the primary client system;

FIG. 6 illustrates the changing of the termination type of a connector on an embodiment of the primary client system;

FIG. 7 illustrates the creating of a new row or column of a sequence diagram on an embodiment of the primary client system;

FIG. 8 illustrates the changing of color of an existing object on an embodiment of the primary client system; and

FIG. 9 illustrates examples of the “scratching gesture”.

### DETAILED DESCRIPTION

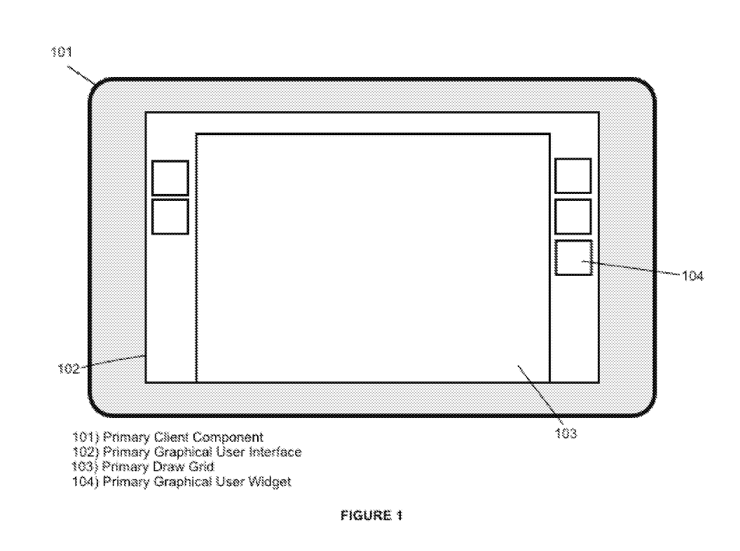

FIG. 1 shows an embodiment of a primary client system 101 that comprises a primary graphical user interface 102. The primary graphical user interface in turn comprises a primary draw grid 103, which in this document may simply be referred to as the draw grid. There may also be GUI widgets/buttons/menus 104 outside the draw grid 103, but within the boundary of the graphical user interface 102. In a preferred embodiment, the primary client system is a portable electronic device such as a mobile phone or a tablet device, the primary graphical user interface is the touch screen of such a device, the primary draw grid is a sub-area within the primary graphical user interface where the user can “draw” shape gestures and control gesture operations, and the pointer used by the user to “draw” on the primary draw grid may be the user's finger or a stylus.

In another preferred embodiment, the primary client system may be a portable electronic device that creates a virtual view for the user, the primary graphical user interface may be a virtual area created by the primary client system for the purposes of interaction with the user, the primary draw grid may be a sub-area or volume within the primary graphical user interface, and the pointer used by the user to “draw” on the draw grid may be a wearable device containing an accelerometer and/or other location sensitive components to ascertain the position of the pointer relative to the draw grid.

The primary user may interact with the primary client system by drawing input gesture operations on the primary draw grid, wherein the input gesture operations include one or more draw shape gestures and one or more control gesture operations.

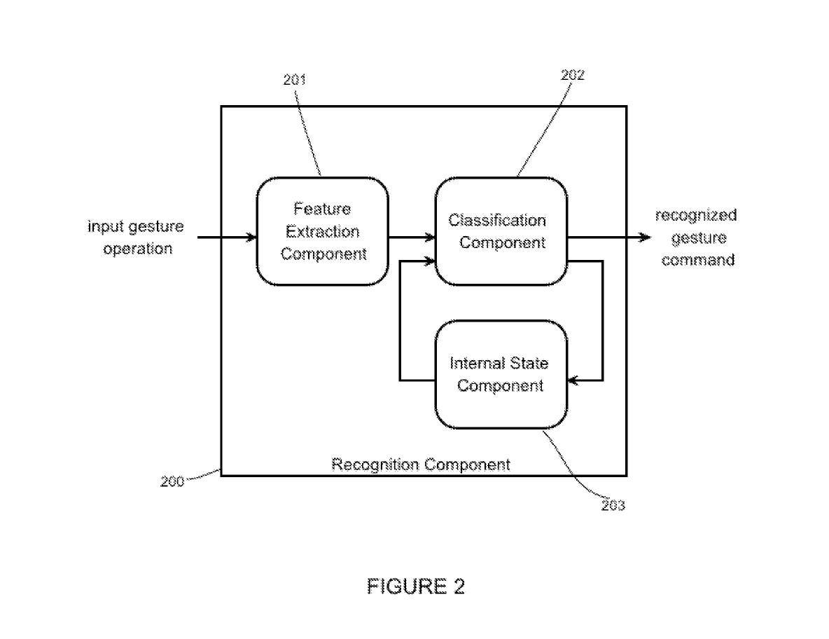

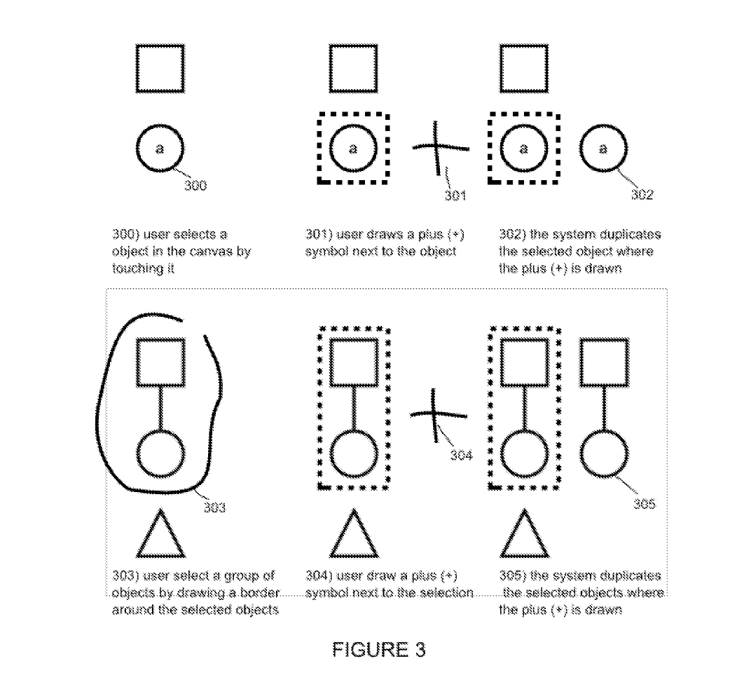

FIG. 2 shows the sub-components of a primary pattern recognition component (PPRC) 200 of an embodiment of a primary client system. Each candidate input gesture operation received by the PPRC is processed by a Feature Extraction Component 201 within the PPRC. The extracted features are then forwarded to the Classification Component 202. Using the state information in the Internal State Component 203 and the extracted features, the Classification Component 202 attempts to recognize a recognized gesture command. The Classification Component may also update the Internal State Component with the latest state information. For example, if the latest recognized gesture command was the creation of a new rectangle, the Internal State Component may be updated with the new rectangle as the “current selection”, such that a new “delete” input gesture operation will be processed in the context of this “current selection”. As another example, in the sequence shown in FIG. 3, the primary user has already drawn a square and a circle using two separate draw shape gestures. These would have been recognized as two separate draw shape commands by the PPRC previously. After selecting some shape(s), in step 301, the primary user also draws an approximate “+” control gesture operation on the draw grid to make a copy of the selected shape(s). The PPRC shown in 200 may interpret this control gesture operation as a control command to copy the selected shapes.

A control gesture operation can involve multiple gesture strokes, who in combination, can comprise the complete control gesture operation.

The PPRC may utilize one or more processors of the primary client system to exercise its functions.

It is important to note that a control gesture operation, as the term is used in this document, does not include clicking or selecting a button that is outside the draw grid to achieve a particular control objective. For example, after selecting some pre-existing shapes, clicking a delete button outside the draw grid (but still in the primary graphical user interface) would not be considered to be a control gesture operation. Moreover, manipulating a control widget would also not be considered to be a control gesture operation (emphasis added). For example, if a pre-existing shape object is selected, it is possible for a draw system to “pop-up” a re-size or move widget that can be further manipulated by the user to achieve a control objective. This approach would also not constitute a control gesture operation in the context of this discussion, as it would involve the manipulation of a control widget. To summarize, in the context of the embodiments described in this document, a control gesture operation is drawn on the draw grid itself to manipulate selected or unselected pre-existing shapes/objects to achieve a particular control objective (e.g. delete, move, change connector type, change connector end type, morph the selected objects, etc.).

### Copy Operation

The process of copying a collection of objects on a draw grid to another area of the draw grid, may comprise the steps of (a) recognizing the outline drawn on the draw grid by the user, where the outline may or may not be a completely closed curve, (b) identifying which existing objects on the draw grid fall within the boundary of the outline drawn in the previous step, (c) recognizing that the user draws an approximate “+” symbol, multi-touch or otherwise, on the draw grid subsequent to the selection of existing objects in the previous step, and (d) duplicating the objects selected in step (b) at the location on the draw grid where the user draw the approximate “+” symbol. In this embodiment of the invention, in step (a), where the outline drawn by the user is not in closed form, for the purposes of identifying the “selected” objects in step (b), the curve may be completed virtually, with or without the completion shown on the draw grid. Alternatively, instead of selecting the shapes to be copied through the outline that was described in steps (a) and (b) above, the user may select the shapes one at a time before proceeding to step (c).

An embodiment of the primary client system that allows the user to copy a collection of objects may comprise one or more processors for performing the steps of: (a) recognizing the outline drawn on the draw grid by the user, where the outline may or may not be a completely closed curve, (b) identifying which existing objects on the draw grid fall within the boundary of the outline drawn in the previous step, (c) recognizing that the user draws an approximate “+” symbol, multi-touch or otherwise, on the draw grid subsequent to the selection of existing objects in the previous step, and (d) duplicating the objects selected in step (b) at the location on the draw grid where the user draw the approximate “+” symbol. In this embodiment of the invention, in step (a), where the outline drawn by the user is not in closed form, for the purposes of identifying the “selected” objects in step (b), the curve may be completed virtually, with or without the completion shown on the draw grid.

Alternatively, the processor of the system may perform the steps of: (a) recognizing the shape object selected by the user using the pointer, (b) recognizing that the user draws an approximate “+” symbol, multi-touch or otherwise, on the draw grid subsequent to the selection of existing object in the previous step, and (c) duplicating the objects selected in step (a) at the location on the draw grid where the user draw the approximate “+” symbol.

FIG. 3 illustrates the steps of a method to copy objects on the draw grid to another part of the draw grid. As can be seen in 300-301, the user selects an object on the draw grid by touching it with a pointer and the system recognizes that selection. Subsequently in 301, the user draws an approximate “+” symbol, multi-touch or otherwise, on the drawing surface and the primary pattern recognition component recognizes the gesture as an attempt to copy. To draw the approximate “+” symbol, the user may draw a substantially horizontal line gesture and an overlapping substantially vertical line gesture. In 302, the primary client system creates a new copy of the selected object where the approximate “+” symbol was drawn.

Alternatively, as can be seen in steps 303-304, the user can select multiple objects by drawing an outline around existing objects on the draw grid and the system will recognize the objects that fall within the boundary. If the outline is not closed, there may be an additional step prior to the recognition of the enclosed objects, where the outline is “virtually” completed to achieve a closed boundary. Subsequently in 304, the user draws an approximate “+” symbol, multi-touch or otherwise, on the drawing surface and the primary pattern recognition component recognizes the gesture as an attempt to copy. In 305, the primary client system creates a new copy of the selected objects where the approximate “+” symbol was drawn.

### Delete Operation

The process of deleting an object shown on the draw grid, may comprise the steps of: (a) selecting an object on the draw grid by the user, (b) recognizing that the user draws a “x” symbol, multi-touch or otherwise, on the draw grid subsequent to the selection of the objection in the previous step, and (c) deleting the selected object and any associated connectors from the draw grid. Alternatively, the user may delete an object by drawing an approximate “x” symbol, multi-touch or otherwise, on an object that is not selected and the primary client system will recognize the request and delete the object in question that has the most overlap with the approximate “x” symbol. With this alternative method, part of the “x” symbol may be on the outside of the shape to be deleted.

An embodiment of the primary client system that allows the user to delete an object may comprise one or more processors for performing the steps of: (a) recognizing the shape object selected by the user using the pointer, (b) recognizing that the user draws an approximate “x” symbol, multi-touch or otherwise, on the draw grid subsequent to the selection of the objection in the previous step, and (c) deleting the selected object and any associated connectors from the draw grid. Alternatively, the user may delete an object by drawing an approximate “x” symbol, multi-touch or otherwise, on an object that is not selected and the system will recognize the request and delete the object in question that has the most overlap with the approximate “x” symbol. With this alternative method, part of the approximate “x” symbol may be on the outside of the shape to be deleted.

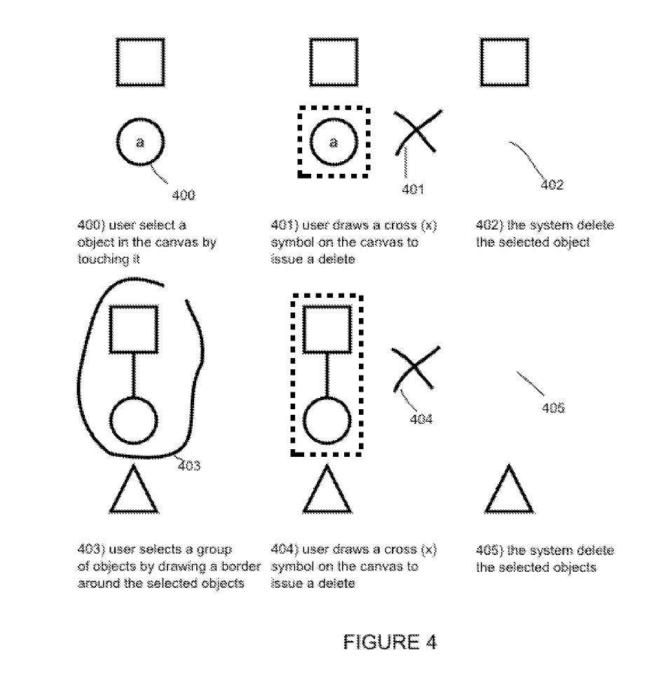

FIG. 4 illustrates the steps of a method to delete objects on the draw grid. As can be seen in 400-401, the user selects an object on the draw grid by touching it with a pointer and the primary client system recognizes that selection. Subsequently in 401, the user draws an approximate “x” symbol, multi-touch or otherwise, on the drawing surface and the PPRC recognizes the gesture as an attempt to delete object(s). To draw the approximate “x” symbol, the user may draw a backward slash gesture and an overlapping forward slash gesture. In 402, the primary client system deletes the object that was previously selected.

Alternatively, as can be seen in step 403-404, the user can select multiple objects by drawing an outline around existing objects on the draw grid and the system will recognize the shapes that fall within the boundary. If the outline is not closed, there may be an additional step prior to the recognition of the enclosed objects, where the outline is “virtually” completed to achieve a closed boundary. Subsequently in 404, the user draws an approximate “x” symbol, multi-touch or otherwise, on the drawing surface and the primary client system recognizes the gesture as an attempt to delete object(s). In 405, the primary client system deletes the objects that were previously selected.

### Change Connector Type Operation

The process of changing the line type of a connector between two objects to a dashed line from a solid line or to a solid line from a dashed line, may comprise the steps of: (a) the user drawing two approximately parallel lines that are in close proximity to each other that are both relatively perpendicular to the connector line at the point of intersection and (b) changing the line type to solid if the current line type is dashed or changing the line type to dashed if the current line type is solid. In a preferred embodiment, the two approximately parallel lines will be considered to be approximately parallel if the angles the two lines make with a base axis is within 20 degrees of each other. Moreover, the two lines will be considered to be relatively perpendicular to the connector line if each of the two lines are between 70 to 110 degrees (20 degrees from perpendicular) from the connector line or curve at the point of intersection.

An embodiment of the primary client system that allows the user to change the line type of a connector between two objects to a dashed line from a solid line or to a solid line from a dashed line may comprise one or more processors for performing the steps of: (a) recognizing that the user has drawn two approximately parallel lines that are in close proximity to each other that are both relatively perpendicular to the connector line or curve at the point of intersection and (b) changing the line type to solid if the current line type is dashed or changing the line type to dashed if the current line type is solid.

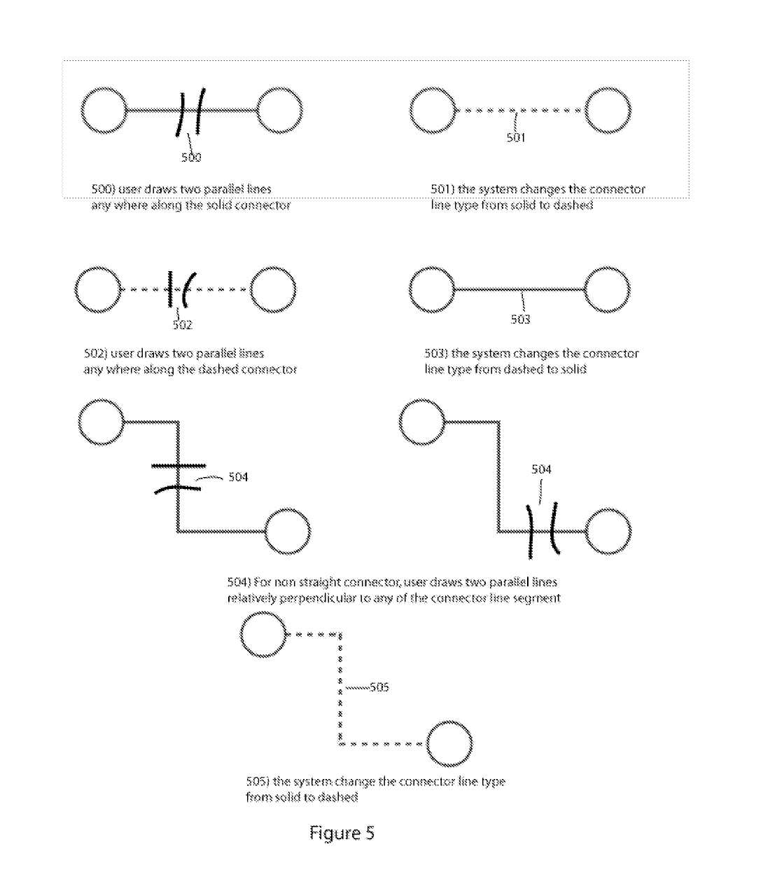

FIG. 5 illustrates the steps of a method to change the line type of a connector between two objects on the draw grid. As can be seen in 500, the user draws two approximately parallel lines that are in close proximity to each other that are both relatively/approximately perpendicular to the solid connector line at the point of intersection. As seen in 501, the primary client system recognizes that these two lines are 1) approximately parallel to each other within a pre-defined degree tolerance, 2) within the thresholds for proximity with respect to each other and 3) within an orientation threshold with respect to the connector curve at the point of intersection, and the line type is changed from solid to dashed. In 502, the user draws two approximately parallel lines that are in close proximity to each other that are both relatively/approximately perpendicular to the dashed connector line at the point of intersection. As seen in 503, the system recognizes that these two lines are 1) approximately parallel to each other within a pre-defined degree tolerance, 2) within the thresholds for proximity with respect to each other and 3) within an orientation threshold with respect to the connector curve at the point of intersection, and the line type is changed from dashed to solid. The two versions of 504 showcase the same steps for a connector that consists of multiple lines. In 504, the user draws two approximately parallel lines that are in close proximity to each other that are both relatively perpendicular to the solid connector line at the point of intersection. As seen in 505, the system recognizes that these lines are approximately parallel, as discussed above, and the line type is changed from solid to dashed.

### Changing Termination Type of Connector

The process of changing the termination type of an existing connector object may comprise the steps of: (a) receiving from the primary user an arrow gesture that overlaps the existing connector object, anywhere on the length of the existing connector, (b) identifying a termination end of the existing connector that corresponds to the direction pointed to by the arrow gesture, wherein the termination end is one of the two endpoints of the existing connector, and (c) changing the termination type of the termination end to the next termination type on a termination type list. In a preferred embodiment, the arrow gesture will take the form of an approximate “>” or “<” gesture and the termination type list will include a list of the permitted terminations types.

An embodiment of the primary client system that allows the user to change the termination type of an existing connector object may comprise one or more processors for performing the steps of: (a) receiving from the primary user an arrow gesture that overlaps the existing connector object, anywhere on the length of the existing connector, (b) identifying a termination end of the existing connector that corresponds to the direction pointed to by the arrow gesture, wherein the termination end is one of the two endpoints of the existing connector, and (c) changing the termination type of the termination end to the next termination type on a termination type list.

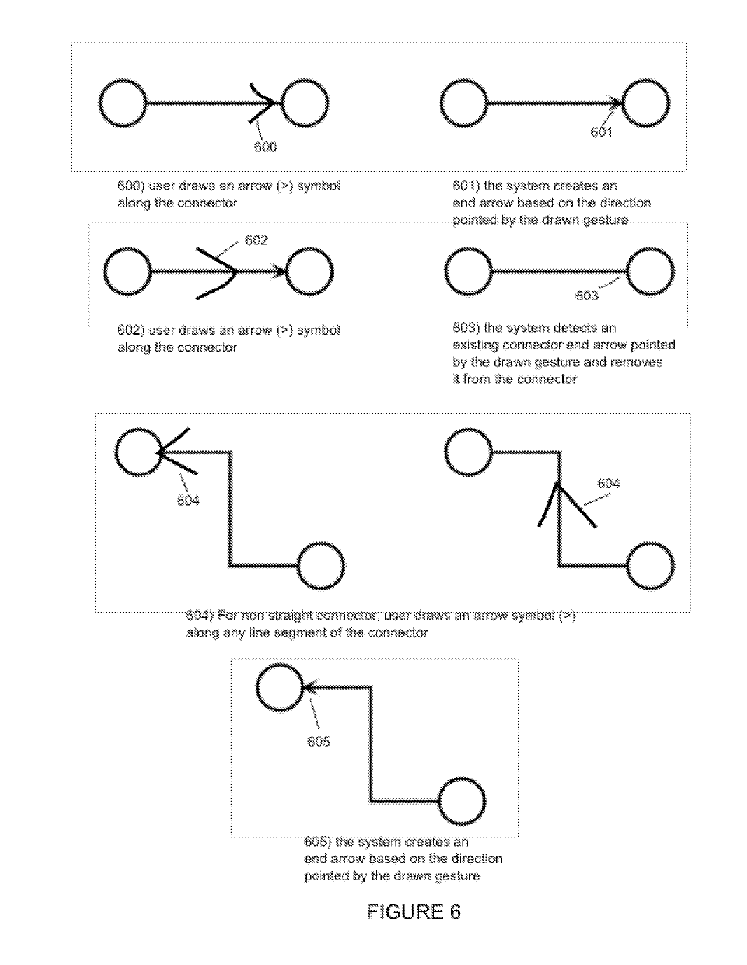

FIG. 6 illustrates the steps of a method to change the termination type of an existing connector object. As can be seen in 600, the user draws an arrow gesture that overlaps the existing connector object, somewhere on the length of the existing connector. As seen in 601, the primary client system, through the pattern recognition component, identifies the termination end of the connector that corresponds to the direction pointed to by the arrow gesture, and changes the termination type to the next termination type in a termination type list. In 602, the user draws an arrow gesture that overlaps the existing connector object that already has an arrow termination type, somewhere on the length of the existing connector. As seen in 603, the primary client system, through the pattern recognition component, identifies the termination end of the connector that corresponds to the direction pointed to by the arrow gesture, and changes the termination type to the next termination type in a termination type list—in this case a blank termination. As can be inferred, in the embodiment shown in FIG. 6, the termination type list wraps around and the list only has two types: 1) blank termination and 2) arrow termination. Steps 604 and 605 demonstrate the same principles as above, but on a multiline connector. Naturally, the same approach may be used on a curved connector as well.

### New Sequence Diagram Operation

The process of creating a new sequence diagram may comprise the steps of: (a) the user drawing an object on the draw grid that is appropriately converted into a standard shape, such as a rectangle, circle or ellipse, on the draw grid, (b) the user drawing a relatively horizontal or vertical line with a starting point inside the object drawn in the previous step that extends to outside the shape, (c) the touch based system inquiring from the user whether a sequence diagram is desired, and (d) if the user answers in the affirmative to the inquiry in the previous step, the touch based system converting the object with a line originating from it, into one of the columns or rows of a standard sequence diagram.

An embodiment of the primary client system that allows the user to create a new sequence diagram may comprise one or more processors for performing the steps of: (a) recognizing that the user has drawn an object on the draw grid that is interpreted as a standard shape, such as a rectangle, circle or ellipse, (b) recognizing that the user has drawn a relatively horizontal or vertical line with a starting point inside the object drawn in the previous step that extends to outside of the shape, (c) displaying a query to the user inquiring whether a sequence diagram is desired, (d) receiving the input from the user to the inquiry from the previous step, and (e) if the user answers in the affirmative to the inquiry in the previous step, converting the object with a line originating from it, into one of the columns or rows of a standard sequence diagram.

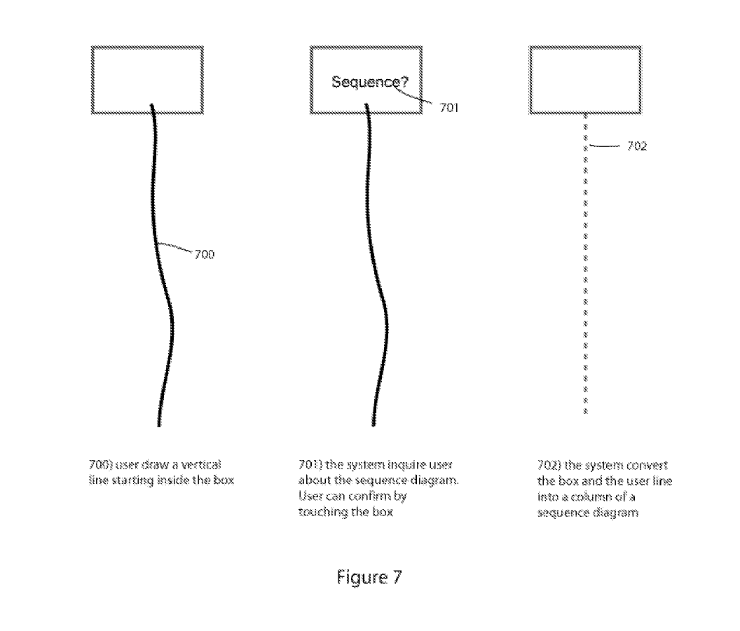

FIG. 7 illustrates the steps of a method to create a new sequence diagram. As can be seen in 700, the user draws a rectangle and then a vertical line downwards where the initial point is inside the rectangle and the end point is outside the rectangle. Optionally, instead of drawing a rectangle, the user could have drawn any other standard shape, such as a circle, ellipse or triangle. In 701, the system recognizes that this is a potential attempt by the user to draw a new column of a sequence diagram and presents a query for the user to answer. As can be seen in 702, it is assumed that the user had answered the query in 701 in the affirmative and the system has created a new column in a sequence diagram. Had the user drawn a horizontal line in 700 instead of the vertical line, every other step being the same, the system would have created a new row in a sequence diagram instead.

### Change Color Operation

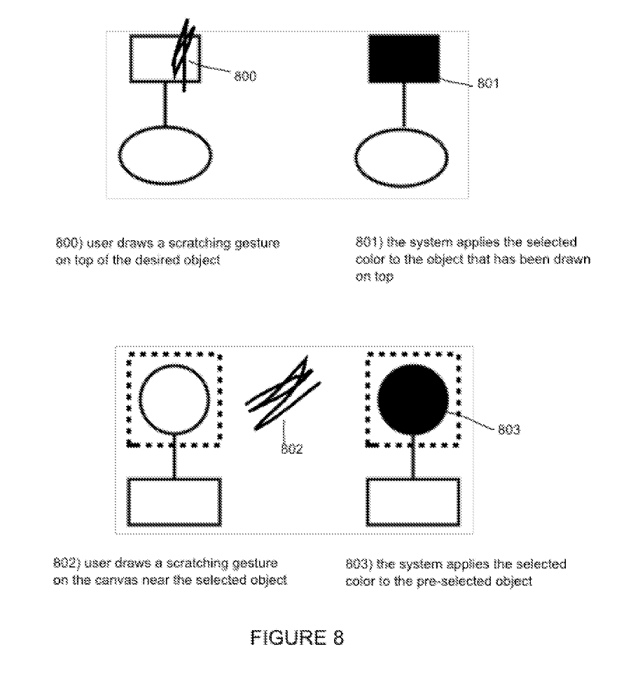

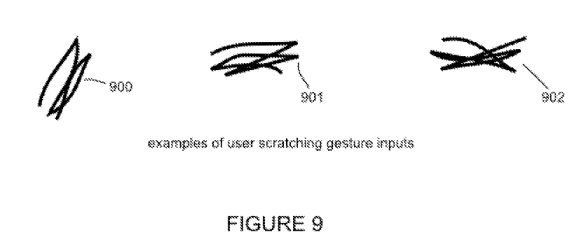

FIG. 8 illustrates the steps of a method to change the color of an existing object displayed on the primary draw grid. As can be seen in 800, the user draws a “scratching gesture” on top of the existing object, whose color is desired to be changed. FIG. 9 illustrates some examples of the “scratching gesture”—where the form should be understood by an average person. Broadly speaking, a scratching gesture will comprise the multiple back and forth movements of the pointer on the draw grid without lifting the pointer from the draw grid. In some respects, the motion resembles the motion a person makes when scratching a lottery ticket. In step 801 of FIG. 8, the primary client system recognizes the scratching gesture and applies the selected color to the existing object. In another embodiment, as seen in 802 the user may pre-select the existing object and may draw the scratching gesture on or near the existing object. As seen in 803, the primary client system recognizes the scratching gesture and applies the selected color to the existing object.

### Other Attributes

In a preferred embodiment of the invention, the primary user may user the primary client system for the purposes of drawing and designing flow chart diagrams, use case diagrams, mind maps, and other relational diagrams.

1. A primary client system that enables gesture based interaction, the primary client system comprising:
a) a primary draw grid that enables interaction between the primary client system and a primary user by means of input gesture operations, wherein the input gesture operations include one or more draw shape gestures and one or more control gesture operations that are drawn within the boundaries of the primary draw grid; and
b) a primary pattern recognition component that interprets each of the input gesture operations into one or more recognized gesture commands.

2. The primary client system in claim 1, wherein the one or more recognized gesture commands include one or more draw shape commands and one or more control commands.

3. The primary client system in claim 1, wherein the primary client system is a portable electronic device and the primary draw grid is a sub-area within the touchscreen of the portable electronic device.

4. The primary client system in claim 1, wherein the one or more control gesture operations include a gesture operation for deleting one or more objects displayed on the primary draw grid by receiving from the primary user:
a) a selection of one or more existing objects displayed on the primary draw grid; and
b) a backward slash gesture and a forward slash gesture drawn by the primary user that are overlapping such that they approximately form the shape of an “X”.

5. The primary client system in claim 1, wherein the one or more control gesture operations include a gesture operation for deleting a delete object displayed on the primary draw grid by receiving from the primary user a backward slash gesture and a forward slash gesture drawn by the primary user that are overlapping such that they approximately form the shape of an “X” and the approximate “X” symbol overlaps the delete object more than it overlaps any other existing object on the draw grid.

6. The primary client system in claim 1, wherein the control gesture operations include a gesture operation for copying one or more objects displayed on the primary draw grid by receiving from the primary user:
a) a selection of one or more existing objects displayed on the primary draw grid; and
b) a substantially horizontal line gesture and a substantially vertical line gesture drawn by the primary user that are overlapping such that they approximately form the shape of an “+”.

7. The primary client system in claim 1, wherein the control gesture operations include a gesture for changing the color of an existing object displayed on the primary draw grid by receiving from the primary user a scratching gesture that substantially overlaps the existing object.

8. The primary client system in claim 1, wherein the control gesture operations include a gesture for changing the line type of an existing connector object on the primary draw grid by receiving from the primary user two line gestures that are substantially parallel to each other and are substantially perpendicular to the existing connector object.

9. The primary client system in claim 1, wherein the control gesture operations include a gesture for changing the termination type of an existing connector object on the primary draw grid by receiving from the primary user an arrow gesture that overlaps the existing connector object, anywhere on the length of the existing connector object.

10. A method that enables gesture based interaction between a primary user and a primary client system that includes a primary draw grid, the method comprising:
a) receiving from the primary client two or more input gesture operations, wherein each input gesture operation is entered by the primary client through the primary draw grid and the two or more input gesture operations include one or more draw shape gestures and one or more control gesture operations drawn within the boundaries of the primary draw grid; and
b) determining two or more recognized gesture commands, by determining, for each of the two or more input gesture operations, one or more recognized gesture commands, wherein the two or more recognized gesture commands include one or more draw shape commands and one or more control commands.

11. The method in claim 10, wherein the primary client system is a portable electronic device and the primary draw grid is a sub-area within the touchscreen of the portable electronic device.

12. The method in claim 10, wherein the one or more control gesture operations include a gesture for deleting one or more objects displayed on the primary draw grid by receiving from the primary user:
a) a selection of one or more existing objects displayed on the primary draw grid; and
b) a backward slash gesture and a forward slash gesture drawn by the primary user that are overlapping such that they approximately form the shape of an “X”.

13. The method in claim 10, wherein the one or more control gesture operations include a gesture operation for deleting a delete object displayed on the primary draw grid by receiving from the primary user a backward slash gesture and a forward slash gesture drawn by the primary user that are overlapping such that they approximately form the shape of an “X” and the approximate “X” symbol overlaps the delete object more than it overlaps any other existing object on the draw grid.

14. The method in claim 10, wherein the one or more control gesture operations include a gesture operation for copying one or more objects displayed on the primary draw grid by receiving from the primary user:
a) a selection of one or more existing objects displayed on the primary draw grid; and
b) a substantially horizontal line gesture and a substantially vertical line gesture drawn by the primary user that are overlapping such that they approximately form the shape of an “+”.

15. The method in claim 10, wherein the one or more control gesture operations include a gesture for changing the color of an existing object displayed on the primary draw grid by receiving from the primary user a scratching gesture that substantially overlaps the existing object.

16. The method in claim 10, wherein the one or more control gesture operations include a gesture for changing the line type of an existing connector object on the primary draw grid by receiving from the primary user two line gestures that are substantially parallel to each other and are substantially perpendicular to the existing connector object.

17. The method in claim 10, wherein the one or more control gesture operations include a gesture for changing the termination type of an existing connector object on the primary draw grid by receiving from the primary user an arrow gesture that overlaps the existing connector object, anywhere on the length of the existing connector.

18. A computer program product for use on a primary client system to enable gesture based interaction during collaboration of content, the computer program product comprising: a non-transitory recording medium and instructions recorded on the non-transitory recording medium for instructing the computer system, the instructions for:
a) receiving from a primary client two or more input gesture operations, wherein each input gesture operation is entered by the primary client through a primary draw grid of the primary client system and the two or more input gesture operations include one or more draw shape gestures and one or more control gesture operations;
b) determining two or more recognized gesture commands, by determining, for each of the two or more input gesture operations an associated recognized gesture command, wherein the two or more recognized gesture commands include one or more draw shape commands and one or more recognized control commands.

19. The computer program product in claim 18, wherein the one or more control gesture operations include a gesture operation for deleting a delete object displayed on the primary draw grid by receiving from the primary user a backward slash gesture and a forward slash gesture drawn by the primary user that are overlapping such that they approximately form the shape of an “X” and the approximate “X” symbol overlaps the delete object more than it overlaps any other existing object on the draw grid.

20. The computer program product in claim 18, wherein the one or more control gesture operations include a gesture operation for copying one or more objects displayed on the primary draw grid by receiving from the primary user:
a) a selection of one or more existing objects displayed on the primary draw grid; and
b) a substantially horizontal line gesture and a substantially vertical line gesture drawn by the primary user that are overlapping such that they approximately form the shape of an “+”.
